(19) United States
(12) Patent Application Publication
(10) Pub. No.: US 2007/0019410 A1
(43) Pub. Date: Jan. 25, 2007

(54) Optical sheet, backlight assembly having the same and display device having the same

(75) Inventors: Dong-Hoon Kim, Seoul (KR); Jeong-Hwan Lee, Suwon-si (KR); Jin-Sung Choi, Cheonan-si (KR); Jin-Mi Jung, Seoul (KR); Jung-Wook Paek, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/490,347

(22) Filed: Jul. 19, 2006

(30) Foreign Application Priority Data
Jul. 19, 2005 (KR) 2005-65090

(51) Int. Cl. F21V 5/00

(52) U.S. Cl. 362/235; 362/332; 362/355; 362/225

(57) ABSTRACT

An optical sheet includes a diffusion layer, a brightness enhancement layer, and a reflecting pattern layer. The diffusion layer diffuses the light generated from a light source, e.g. a lamp. The brightness enhancement layer is on the diffusion layer. The reflecting pattern layer is between the brightness enhancement layer and includes a gap and a reflective structure in a first region and a second region, respectively. to the reflective structure maintains a distance between the brightness enhancement layer and the diffusion layer. The optical sheet is useful for enhancing the luminance of the light from the lamp. When used with a backlight assembly for a display device, the optical sheet is capable of enhancing the luminance while also decreasing the overall thickness of the backlight assembly.

### CROSS-REFERENCE TO RELATED APPLICATION

The present application claims priority from Korean Patent Application No. 2005-65090, filed on Jul. 19, 2005, the disclosure of which is hereby incorporated herein by reference in its entirety.

### BACKGROUND OF THE INVENTION

1. Field of the Invention

The present invention relates to an optical sheet, a backlight assembly having the optical sheet and a display device having the optical sheet. More particularly, the present invention relates to an optical sheet capable of increasing luminance without increasing the thickness, a backlight assembly having the optical sheet and a display device having the optical sheet.

2. Description of the Related Art

There are many types of display devices available today. Some commonly used types of display devices include liquid crystal display (LCD) device, organic light emitting display (OLED) device, plasma display panel (PDP) device, etc. Of these different types of displays, LCD device has numerous characteristics that make it desirable for popular consumer electronics, such as thinness, low power consumption, and light weight.

An LCD device includes an LCD panel. The LCD panel includes a liquid crystal layer interposed between two substrates having electrodes. Liquid crystals of the liquid crystal layer change their arrangement in response to an electric field applied to the liquid crystal layer so that light transmittance through the liquid crystal layer is changed to display the desired image.

An LCD device displays images using a separate light source, often provided in the form of a backlight assembly that generates light. The backlight assembly includes a reflecting sheet, optical sheets, a diffusion plate and a lamp assembly. The lamp assembly is between the diffusion plate and the reflecting sheet, and generates light. The reflecting sheet is under the lamp assembly so that a portion of the light generated from the lamp assembly is reflected. The optical sheets include a diffusion sheet and a prism sheet.

When the optical sheets become larger, the manufacturing process of the LCD device is more complicated. Therefore, the manufacturing cost of the LCD device is increased.

### SUMMARY OF THE INVENTION

The present invention provides an optical sheet capable of increasing luminance without increasing the thickness. The present invention also provides a backlight assembly having the above-mentioned optical sheet and a display device having the above-mentioned optical sheet.

In one aspect, the invention is an optical sheet for changing the optical characteristics of light generated by a lamp. The optical sheet includes a diffusion layer, a brightness enhancement layer, and a reflecting pattern layer. The diffusion layer diffuses the light generated by the lamp. The brightness enhancement layer is on the diffusion layer. The reflecting pattern layer is between the brightness enhancement layer and includes a gap and a reflective structure in a first region and a second region, respectively. The reflective structure maintains a distance between the brightness enhancement layer and the diffusion layer.

In another aspect, the invention is a backlight assembly that includes a lamp, a transparent plate and an optical sheet. The lamp generates light. The transparent plate is on the lamp. The optical sheet includes a diffusion layer, a brightness enhancement layer and a reflecting pattern layer. The diffusion layer receives and diffuses the light coming out of the transparent plate. The brightness enhancement layer is on the diffusion layer. The reflecting pattern layer is between the diffusion layer and the brightness enhancement layer and includes a reflective structure and a gap.

In yet another aspect, the invention is a display device that includes a display unit and a backlight assembly. The display unit displays an image. The backlight assembly includes a lamp, a transparent plate and an optical sheet. The lamp generates light. The transparent plate is on the lamp. The optical sheet includes a diffusion layer, a brightness enhancement layer on the diffusion layer, and a reflecting pattern layer between the diffusion layer and the brightness enhancement layer. The reflecting pattern layer includes a reflective structure and a gap.

According to the present invention, the diffusion layer is integrally formed with the brightness enhancement layer, and the gap is formed between the diffusion layer and the brightness enhancement layer along with the reflective structure. Therefore, a manufacturing process is simplified, and the luminance is increased.

### BRIEF DESCRIPTION OF THE DRAWINGS

The above and other advantages of the present invention will become more apparent by describing in detail exemplary embodiments with reference to the accompanying drawings, in which:

FIG. 1 is an exploded perspective view showing a backlight assembly in accordance with one embodiment of the present invention;

FIG. 2 is a cross-sectional view taken along the line I-I′ shown in FIG. 1;

FIG. 3A is a cross-sectional view showing the optical sheet of FIG. 1;

FIG. 3B is a cross-sectional view showing an optical sheet in accordance with another embodiment of the present invention;

FIG. 3C is a cross-sectional view showing an optical sheet in accordance with yet another embodiment of the present invention;

FIGS. 4A to 4C are cross-sectional views showing a method of forming a reflecting pattern layer of FIG. 3A;

FIG. 5 is a cross-sectional view showing the function of an air layer shown in FIG. 3A; and

FIG. 6 is an exploded perspective view showing a liquid crystal display (LCD) device in accordance with one embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

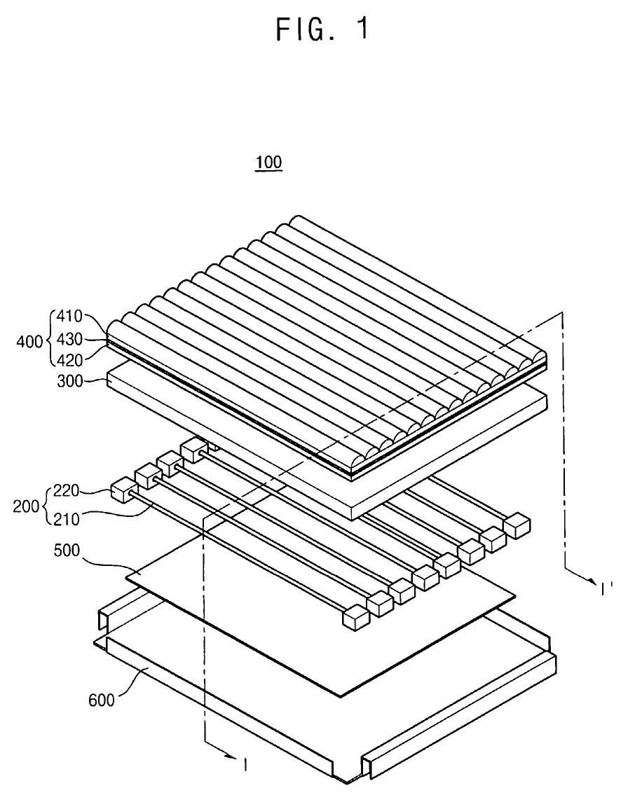

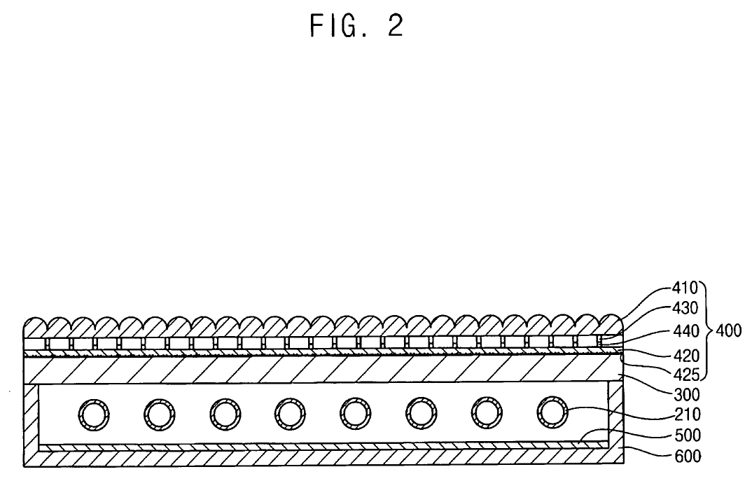

FIG. 1 is an exploded perspective view showing a backlight assembly in accordance with one embodiment of the present invention. FIG. 2 is a cross-sectional view taken along the line I-I′ shown in FIG. 1.

Referring to FIGS. 1 and 2, the backlight assembly 100 includes a lamp unit 200, a diffusion plate 300, optical sheets 400, a reflecting plate 500 and a receiving container 600.

The lamp unit 200 includes a plurality of lamps 210 and a lamp holder 220. The lamps 210 may be arranged substantially parallel to each other. The lamp holder 220 holds end portions of the lamps 210. Each of the lamps 210 may include a cold cathode fluorescent lamp (CCFL) having a rod shape. Each of the lamps 210 includes a hot electrode (not shown) and a cold electrode (not shown). A voltage level of the cold electrode (not shown) may be lower than that of the hot electrode (not shown). The lamp holder 220 may cover the hot and cold electrodes (not shown) of the lamps 210.

The diffusion plate 300 is on the lamp unit 200 to diffuse the light generated from the lamp unit 200. The diffusion plate 300 supports the optical sheets 400. The diffusion plate 300 may include a transparent material. Examples of the transparent material that can be used for the diffusion plate 300 include polycarbonate (PC), polymethylmethacrylate (PMMA), etc. When the diffusion plate 300 includes the transparent material, the luminance of the backlight assembly 100 is increased.

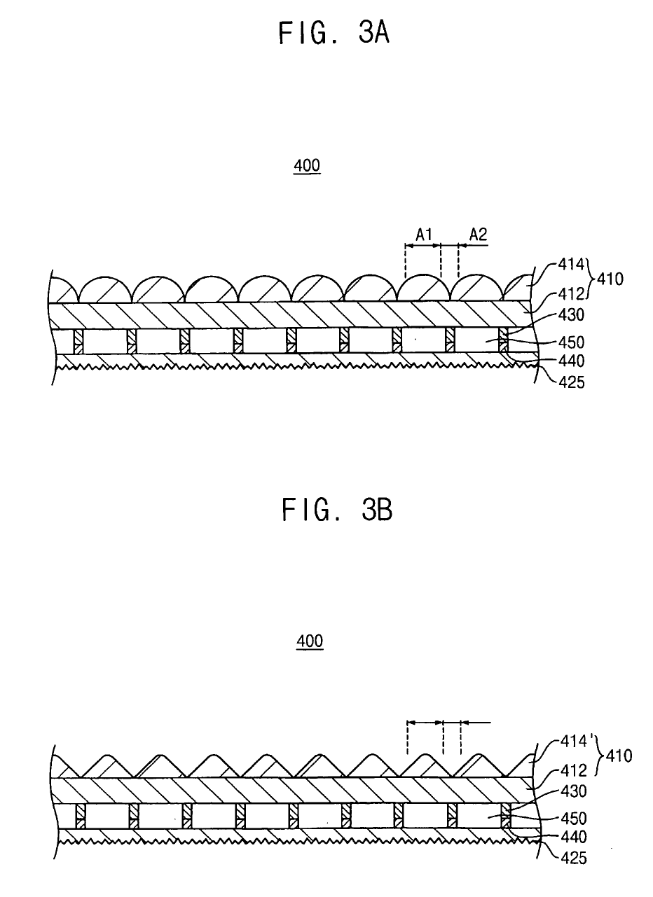

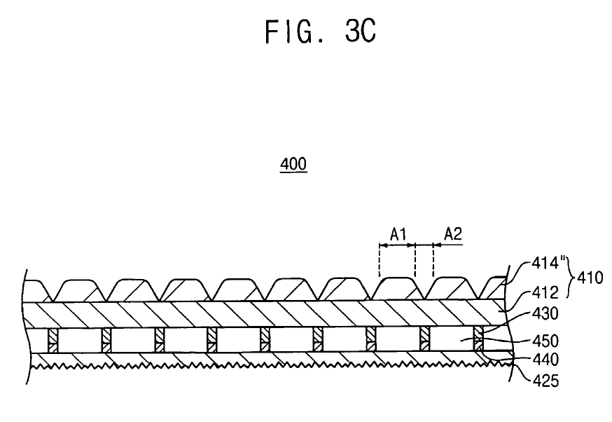

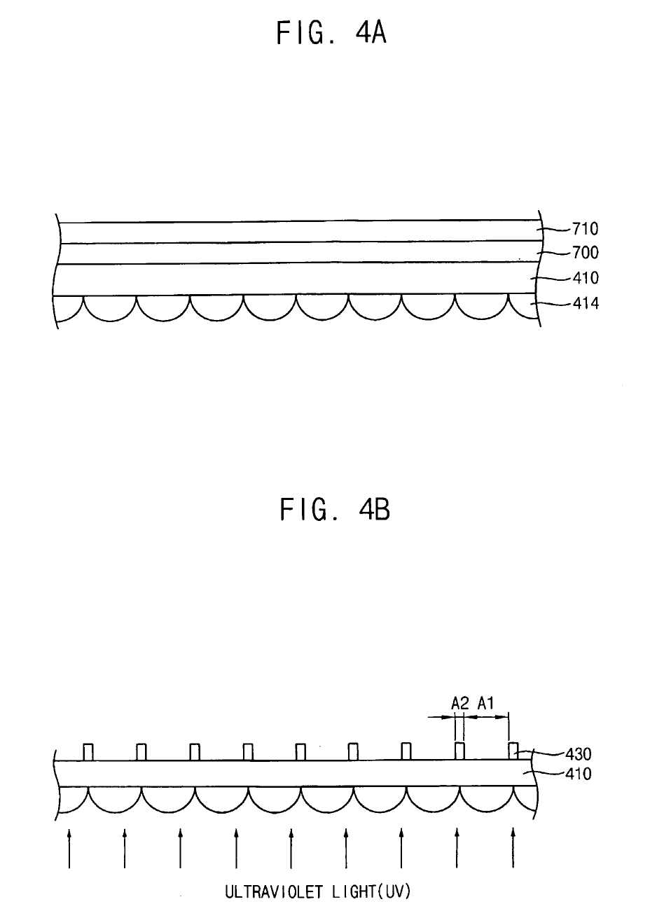

The optical sheet 400 includes a bright enhancement layer 410 and a diffusion layer 420. The brightness enhancement layer 410 increases the luminance of light when viewed on a plane. The brightness enhancement layer 410 diffuses light. The diffusion layer 420 may be integrally formed under the brightness enhancement layer 410. The optical sheets 400 may further include a reflective structure 430 and an adhesive pattern 440. A gap 450 (shown in FIG. 3A) is formed between the brightness enhancement layer 410 and the diffusion layer 420 by the reflective structure 430 and the adhesive pattern 440. The gap 450 may be an air layer, a vacuum layer, an inert gas layer, etc. The reflective structure 430, the adhesive pattern 440, and the gap 450 form what is herein referred to as the reflective pattern layer.

FIG. 3A is a cross-sectional view showing the optical sheet 400 of FIG. 1.

Referring to FIG. 3A, the optical sheets 400 includes the brightness enhancement layer 410, the diffusion layer 420, the reflective structure 430 and the adhesive pattern 440.

The brightness enhancement layer 410 includes a base film 412 and a plurality of lenses 414. The base film 412 contains polycarbonate (PC). The lenses 414 are formed on the base film 412. The lenses 414 extend in the same direction as the lamps 210 (shown in FIG. 1) and have a semicircular cross-section.

The brightness enhancement layer 410 includes a first region A1 and a second region A2. The first region A1 corresponds to the lenses 414. The second region A2 is between the lenses 414. The average height of the first region A1 may be greater than the average height of the second region A2.

The brightness enhancement layer 410 increases the luminance of light when viewed on the plane and also diffuses the light to increase the luminance uniformity of the light. That is, light is refracted by the lenses 414 to decrease the bright line that is formed by the backlight assembly 100. Thus, the distance between the lamps 210 and the brightness enhancement layer 410 is decreased to reduce the overall thickness of the backlight assembly 100.

FIGS. 1 to 3A depict an embodiment where each of the lenses 414 has a semicircular cross-section.

FIGS. 3B and 3C are cross-sectional views showing the optical sheet 400 in accordance with other embodiments of the present invention. The optical sheet 400 of FIGS. 3B and 3C are the same as in FIG. 3A except the shape of the lenses. Thus, the same reference numerals will be used to refer to the same or like parts as those described in FIGS. 1 to 3A and any further explanation concerning the above elements will be omitted.

In the embodiment of FIG. 3B, each of the lenses 414 has a substantially triangular cross-section with the corners rounded. In the embodiment of FIG. 3C, each of the lenses 414″ has a substantially trapezoidal shape with the corners rounded.

In the embodiments of FIGS. 3A, 3B, and 3C, a plurality of embossed patterns 425 may be formed on a lower surface of the diffusion layer 420 to diffuse the light generated from the lamps 210. The embossed patterns 425 may be protrusions or roughness formed on the lower surface of the diffusion layer 420. The embossed patterns 425 may be formed through a sand blasting process. In FIGS. 1 to 3A, a diffusion bead that includes a particle having different refractive index from a remaining portion of the diffusion layer 420 may not be contained in the diffusion layer 420.

When light is diffused by the diffusion bead, the light exits the diffusion layer 420 at an angle greater than about 42′ with respect to a line normal to the exit surface. The angle at which light exits a surface, measured with respect to an imaginary line that is normal to the surface through which the light exits, is herein referred to as the “exit angle.” When the exit angle of the light is greater than about 42°, luminance of the backlight assembly 100 when viewed from the front is decreased. The “front” of the backlight assembly 100, as used herein, refers to the part of the assembly that acts as the primary light exit surface. In case of FIG. 1, for example, the “front” is the top and the “rear” is the bottom. In FIGS. 1 to 3A, there is no diffusion bead in the diffusion layer 420, as the light is diffused by the embossed patterns 425. Due to the presence of the embossed patterns 425, the amount of light having an exit angle of greater than about 42′ is decreased.

The reflective structure 430 may be integrally formed with the brightness enhancement layer 410 on a lower surface of the brightness enhancement layer 410. The reflective structure 430 is in the second region A2 of the brightness enhancement layer 410. The reflective structure 430 extends in the same direction as the lamps 210, and has a predetermined height. The reflective structure 430 includes a reflective material. Examples of the reflective material that can be used for the reflective structure 430 include titanium dioxide, silver, white polyethyleneterephthalate (PET), etc.

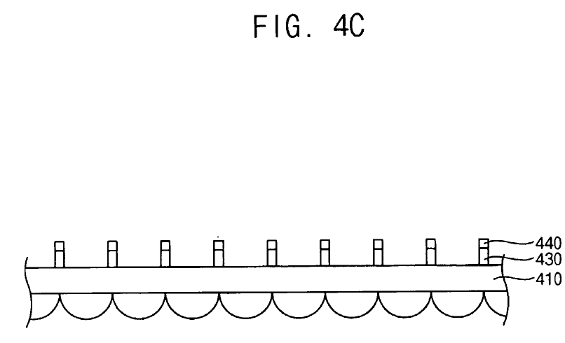

FIGS. 4A to 4C are cross-sectional views showing a method of forming the reflective structure 430 shown in FIG. 3A.

Referring to FIG. 4A, a reflective material layer 700 is formed on the lower surface of the brightness enhancement layer 410. The reflective material layer 700 includes a reflective material, examples of which include titanium dioxide, silver, white polyethyleneterephthalate (PET), etc. The lenses 414 are formed on an upper surface of the brightness enhancement layer 410.

A photoresist layer 710 is formed on the reflective material layer 700. The photoresist layer 710 may include an ultraviolet curable resin.

Referring to FIG. 4B, is the lenses 414 are irradiated by ultraviolet light supplied from a lower portion of the brightness enhancement layer 410 toward the photoresist layer 710. The first region A1 has a greater average height than the second region A2 by the lenses 414.

The portion of the photoresist layer 710 in the first region A1 is cured or solidified differently from the photoresist layer 710 in the second region A2. More specifically, the portion of the photoresist layer 710 in the first region A1 is cured to a less extrent than the photoresist layer 710 in the second region A2 so that the portion of the photoresist layer 710 in the first region A1 is easily removed through a development process.

During the patterning process for the reflective material layer 700, the solidified photoresist layer 710 is used as a mask while removing the reflective material layer 700 in the first region A1. Through this patterning process, the reflective structure 430 is formed in the second region A2 of the brightness enhancement layer 410, as shown in FIG. 4B.

Referring to FIG. 4C, the adhesive pattern 440 is formed on the reflective structure 430. For example, an adhesive material coated on a printing substrate (not shown) or a printing roller (not shown) is printed on the reflective structure 430 to form the adhesive pattern 440. Alternatively, the adhesive material may be directly coated on the reflective structure 430 through a mask (not shown) to form the adhesive pattern 440. In another embodiment, the adhesive pattern 440 may be formed through various methods. The adhesive material may include various adhesives such as organic adhesives, inorganic adhesives, thermally curable resin, light curable resin, etc.

Referring again to FIG. 2, the diffusion layer 420 is attached to the reflective structure 430 through the adhesive pattern 440. This way, the brightness enhancement layer 410 is integrated with the reflecting pattern layer and the diffusion layer 420.

The gap 450 is formed between the brightness enhancement layer 410 and the diffusion layer 420 by the reflective structure 430 and the adhesive pattern 440. To form the gap 450, the brightness enhancement layer 410 is spaced apart from the diffusion layer 420 by the reflective structure 430 and the adhesive pattern 440, The heights of the reflective structure 430 and the adhesive pattern 440 may be irregular. Air may be injected into the space between the brightness enhancement layer 410 and the diffusion layer 420 to fill the gap 450. There are multiple gaps 450, as the space between the diffusion layer 420 and the brightness enhancement layer 410 is divided into a plurality of sections by the reflective structure 430 and the adhesive pattern 440.

The gap 450 between the brightness enhancement layer 410 and the diffusion layer 420 controls the exit angle of the light that passes through the diffusion layer 420. In particular, the gap 450 decreases the exit angle for light that would have had an exit angle greater than about 42° without the gap 450. Keeping the exit angle no greater than about 42° increases the luminance when viewed from the front.

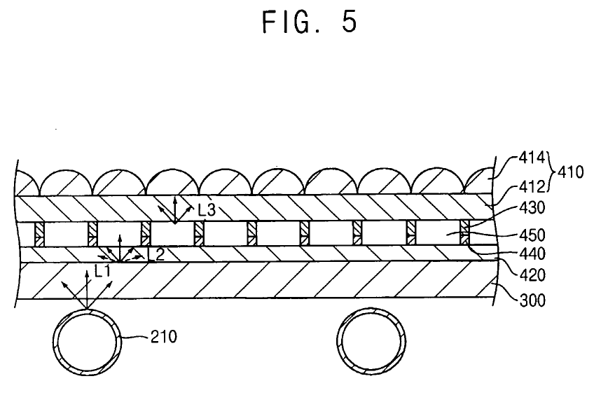

FIG. 5 is a cross-sectional view showing the function of the gap 450 of FIG. 3A.

Referring to FIG. 5, first light L1 generated from the lamps 210 passes through the diffusion plate 300 to be incident on the diffusion layer 420. Second light L2 passes through the diffusion layer 420 and enters the gap 450. The portion of a second light L2 that passes through the diffusion layer 420 exits the diffusion layer 420 at an exit angle greater than about 42°.

The second light L2 passes through the gap 450 to be incident on the brightness enhancement layer 410. Third light L3 that passed through the gap 450 has a smaller exit angle coming out of the base film 412 than the second light L2 coming out of the diffusion layer 420. The amount of light having an exit angle of more than about 42° is decreased by the gap 450.

The luminance of the third light L3, when viewed from the front, is increased by the brightness enhancement layer 410.

Referring again to FIG. 3A, some of the light that is refracted by the brightness enhancement layer 410 toward the rear of the backlight assembly 100 is reflected by the reflective structure 430 back toward the brightness enhancement layer 410. Thus, the reflective structure 430 enhances the luminance of the backlight assembly 100.

Referring again to FIGS. 1 and 2, the reflecting plate 500 is under the lamp unit 200, and some of the light generated from the lamp unit 200 is reflected from the reflecting plate 500 toward the diffusion plate 300.

The receiving container 600 is under the reflecting plate 500. The receiving container 600 includes a base plate and a side wall that extends from the sides of the base plate. The optical sheets 400, the diffusion plate 300 and the lamp unit 200 are received in the receiving space as shown in FIG. 1.

The backlight assembly 100 includes the diffusion plate 300, which is transparent, to increase the luminance. The brightness enhancement layer 410 includes the lenses 414 to decrease the bright line formed by the lamps 210 and to decrease the overall thickness of the backlight assembly 100.

In addition, the amount of light having an exit angle that is greater than about 42° is decreased by the gap 450 between the brightness enhancement layer 410 and the diffusion layer 420 to increase the luminance of the light when viewed from the front of the backlight assembly 100. Although the diffusion layer 420 does not include the diffusion bead, the amount of light having an exit angle greater than about 42′ is decreased. Therefore, the luminance of the backlight assembly 100 is increased.

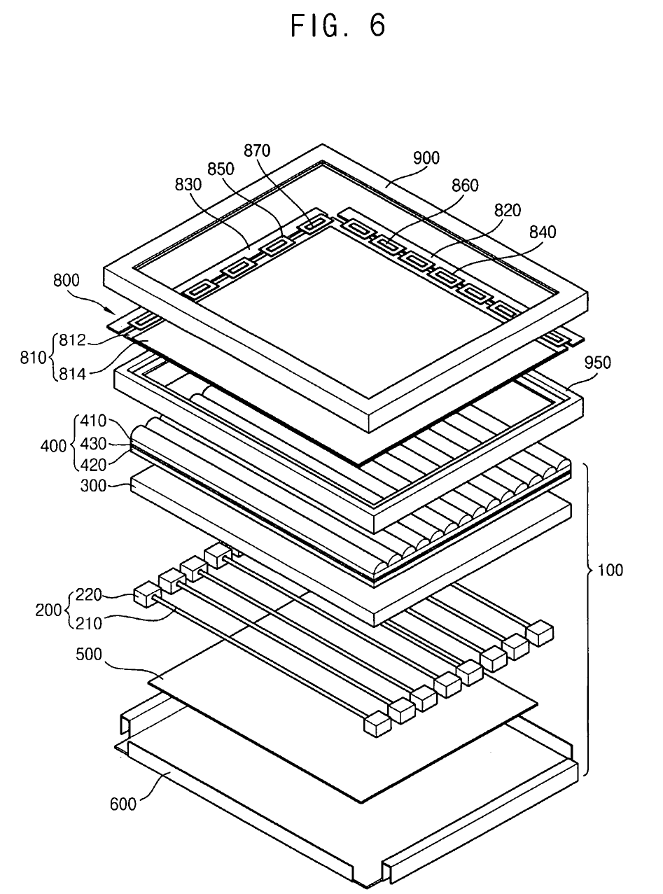

FIG. 6 is an exploded perspective view showing a liquid crystal display (LCD) device in accordance with one embodiment of the present invention. A backlight assembly 100 of FIG. 6 is the same as in FIGS. 1 to 3A. Thus, the same reference numerals will be used to refer to the same or like parts as those described in FIGS. 1 to 3A and any redundant explanation concerning the above elements will be omitted.

Referring to FIG. 6, the LCD device includes a backlight assembly 100, a display unit 800 and a top chassis 900. The backlight assembly 100 generates light. The display unit 800 displays an image based on the light generated from the backlight assembly 100. The top chassis 900 fixes the display unit 800 to the backlight assembly 100.

The backlight assembly 100 includes a lamp unit 200, a diffusion plate 300 and optical sheets 400. The lamp unit 200 generates light. The diffusion plate 300 is on the lamp unit 200 to diffuse the light generated from the lamp unit 200. The optical sheets 400 are on the diffusion plate 300 to enhance the optical characteristics of the light that passed through the diffusion plate 300.

The backlight assembly 100 may further include a reflecting plate 500 and a receiving container 600. The reflecting plate 500 is under the lamp unit 100 so that light generated from the lamp unit 200 that was emitted toward the rear of the LCD device is reflected toward the front of the LCD device by the reflecting plate 500. The receiving container 600 is under the reflecting plate 500 to receive the lamp unit 200, the diffusion plate 300 and the optical sheets 400.

The optical sheets 400 include the brightness enhancement layer 410, the diffusion layer 420, the reflective structure 430 and the adhesive pattern 440. The optical sheets 400 may further include the gap 450 formed between the brightness enhancement layer 410 and the diffusion layer 420 by the reflective structure 430 and the adhesive pattern 440.

The gap 450 controls an exit angle of the light that has passed through the diffusion layer 420 so that the brightness enhancement layer 410 increases the luminance of the LCD device when viewed from the front. The “front” of the LCD device is the part of the device that, when assembled, acts as the primary light exiting surface. In case of FIG. 6, the “front” is the top and the “rear” is the bottom.

The display unit 800 includes an LCD panel 810, a source printed circuit board (PCB) 820 and a gate PCB 830. The LCD panel 810 displays images. The source PCB 820 and the gate PCB 830 apply driving signals to the LCD panel 810.

The driving signals that are from the source PCB 820 and the gate PCB 830 may be applied to the LCD panel 810 through the data flexible circuit film 830 and a gate flexible circuit film 840, respectively. Each of the data and gate flexible circuit films 830 and 840 includes a tape carrier package (TCP) or a chip on film (COF).

The data and gate flexible circuit films 830 and 840 include a data driving chip 860 and a gate driving chip 870, respectively, to control the application of driving signals to the LCD panel 810.

The LCD panel 810 includes a thin film transistor (TFT) substrate 812, a color filter substrate 814 and a liquid crystal layer (not shown). The color filter substrate 814 corresponds to the TFT substrate 812. The liquid crystal layer (not shown) is interposed between the TFT substrate 812 and the color filter substrate 814.

The TFT substrate 812 includes a glass substrate and a plurality of thin film transistors (not shown) that are formed on the glass substrate in a matrix configuration. The thin film transistors (not shown) are switching elements. Data lines are electrically connected to source electrodes of the thin film transistors (not shown). Gate lines are electrically connected to gate electrodes of the thin film transistors (not shown). A pixel electrode that may include a transparent conductive material is electrically connected to a drain electrode of each of the thin film transistors (not shown).

The color filter substrate 814 is spaced apart from the TFT substrate 812 by a predetermined distance. The color filter substrate 814 includes red, green and blue color filters for displaying a color image. The color filter substrate 814 may further include a common electrode that is on substantially all of the color filter substrate 814.

When electric power is applied to the gate electrode of one of the thin film transistors, the thin film transistor is turned on to form an electric field between the pixel electrode and the common electrode. Liquid crystals of the liquid crystal layer (not shown) change their arrangement in response to the electric field applied to the liquid crystals, and thus light transmittance through the liquid crystal layer (not shown) is changed, thereby displaying the image based on the light that is from the backlight assembly 100.

The source PCB 820 is electrically connected to an end portion of the TFT substrate 812 through the data flexible circuit film 840. The gate PCB 830 is electrically connected to another end portion of the TFT substrate 812 through the gate flexible circuit film 850. The source PCB 820 applies a data driving signal to the LCD panel 810. The gate PCB 830 applies a gate driving signal to the LCD panel 810.

In particular, the data driving signal is applied to the data lines of the TFT substrate 812 through the data flexible circuit film 840. In particular, the gate driving signal is applied to the gate lines of the TFT substrate 812 through the gate flexible circuit film 850. The TFT substrate 812 may further include a conductive line (not shown) through which the data flexible circuit film 840 is electrically connected to the gate flexible circuit film 850.

The display unit 800 is on the backlight assembly 100. The LCD panel 810 is on an upper mold frame 950 that is on the backlight assembly 100. The data flexible circuit film 840 is bent so that the source PCB 820 is on the rear surface of the receiving container 600.

The top chassis 900 surrounds the LCD panel 810 that is on the backlight assembly 100, and is combined with the receiving container 600. The top chassis 900 protects the LCD panel 810 from an externally provided impact, and prevents a drifting of the LCD panel 810.

In FIG. 6, the display device is the LCD device. Alternatively, the display device may be an electrophoresis display device, an organic light emitting display (OLED) device, etc.

According to the present invention, the diffusion layer 420 is integrally formed with the brightness enhancement layer 410, and the gap 450 is formed between the brightness enhancement layer 410 and the diffusion layer 420 by the reflective structure 430.

Therefore, a manufacturing process of the backlight assembly is simplified to decrease the manufacturing cost of the backlight assembly 100.

In addition, the gap 450 between the diffusion layer 420 and the brightness enhancement layer 410 controls the exit angle of the light that has passed through the diffusion layer so that the brightness enhancement layer increases the luminance of the light from the front of the device and diffuses the light.

Furthermore, the lenses that increase the luminance of the light from the front and diffuse the light are formed on the brightness enhancement sheet to decrease the bright line, thereby increasing the luminance uniformity of the backlight assembly. Also, the distance between the lamps and the brightness enhancement sheet is decreased, thereby decreasing a thickness of the backlight assembly.

In addition, the diffusion layer 420 does not include the diffusion bead, and the embossed pattern is formed on the diffusion layer 420 to prevent a decrease in the luminance of the light exiting the diffusion layer 420.

Furthermore, the backlight assembly 100 includes the transparent diffusion plate 300 to increase the luminance of the backlight assembly.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. An optical sheet for changing the optical characteristics of light generated by a lamp, the optical sheet comprising:
a diffusion layer that diffuses the light generated by the lamp;
a brightness enhancement layer on the diffusion layer; and
a reflecting pattern layer positioned between the brightness enhancement layer and the diffusion layer, the reflecting pattern layer including a reflective structure that maintains a distance between the brightness enhancement layer and the diffusion layer and a gap, wherein the gap is in a first region and the reflective structure is in a second region.

2. The optical sheet of claim 1, wherein the diffusion layer comprises a plurality of embossed patterns.

3. The optical sheet of claim 1, wherein the brightness enhancement layer comprises:
a base film; and
a plurality of lenses on the base film.

4. The optical sheet of claim 3, wherein each of the lenses that are adjacent to each other extend in a longitudinal direction of the lamps, and has a substantially semicircular cross-section.

5. The optical sheet of claim 3, wherein each of the lenses that are adjacent to each other extend in a longitudinal direction of the lamps, and has a substantially triangular cross section with its corners rounded.

6. The optical sheet of claim 3, wherein each of the lenses that are adjacent to each other extend in a longitudinal direction of the lamps, and has a substantially trapezoidal cross section with its corners rounded.

7. The optical sheet of claim 3, wherein the second region corresponds to a region between the lenses and extends in a longitudinal direction of the lamps.

8. The optical sheet of claim 1, wherein the reflecting pattern layer is integrally formed with the brightness enhancement layer under the brightness enhancement layer.

9. The optical sheet of claim 1, wherein the reflecting pattern comprises at least one material selected from the group consisting of titanium dioxide, silver and white polyethyleneterephthalate (PET).

10. The optical sheet of claim 1, further comprising an adhesive pattern between the reflective structure and the diffusion layer, the adhesive pattern attaching the diffusion layer to the reflecting pattern.

11. A backlight assembly comprising:
a lamp generating light;
a transparent plate on the lamp; and
an optical sheet including:
a diffusion layer that receives and diffuses the light coming out of the transparent plate;
a brightness enhancement layer on the diffusion layer; and
a reflecting pattern layer between the diffusion layer and the brightness enhancement layer, the reflecting pattern layer including a reflective structure and a gap.

12. The backlight assembly of claim 11, wherein the brightness enhancement layer comprises:
a base film; and
a plurality of lenses on the base film.

13. The backlight assembly of claim 11, wherein the brightness enhancement layer comprises a first region and a second region having a lower average height than the first region, the reflective structure being in the second region and extending in a longitudinal direction of the lamps.

14. The backlight assembly of claim 11, wherein the reflecting pattern is integrally formed with brightness enhancement layer under the brightness enhancement layer.

15. The backlight assembly of claim 11, further comprising an adhesive pattern between the reflecting pattern and the diffusion layer so that the diffusion layer is attached to the reflecting pattern.

16. A display device comprising:
a display unit that displays an image; and
a backlight assembly including:
a lamp generating light;
a transparent plate on the lamp; and
an optical sheet including a diffusion layer, a brightness enhancement layer on the diffusion layer, and a reflecting pattern layer between the diffusion layer and the brightness enhancement layer, the reflecting pattern layer including a reflective structure and a gap.
